(19) United States
(12) Patent Application Publication
(10) Pub. No.: US 2006/0065370 A1
(43) Pub. Date: Mar. 30, 2006

(54) Labeling machine for heat-shrink labels

(75) Inventor: Mario Ballarotti, Marmirolo (IT)

Correspondence Address: MODIANO & ASSOCIATI, Via Meravigli, 16, Milan, 20123, IT

(73) Assignee: P.E. S.R.L.

(21) Appl. No.: 11/226,255

(22) Filed: Sep. 15, 2005

(30) Foreign Application Priority Data
Sep. 24, 2004 (IT) MN2004A000024

(51) Int. Cl. B65C 9/06

(52) U.S. Cl. 156/379.8; 156/447

(57) ABSTRACT

A labeling machine for heat-shrink labels, comprising, arranged progressively along the path of the bottles: a first adhesive bonding device, which applies to the surface of a bottle a film of adhesive at a strip of limited dimensions; a transfer drum, which conveys a label from a second adhesive bonding device, which arranges a film of adhesive that polymerizes as a consequence of exposure to UV rays on the trailing edge of the label, until contact occurs with a bottle so that the leading edge of the label is located at the film of adhesive; and at least one UV-ray emission lamp.

The present invention relates to a labeling machine for heat-shrink labels.

### BACKGROUND OF THE INVENTION

It is known that bottles manufactured as solids of revolution and having a contoured profile, such as a cylindrical surface in the central region with two protrusions at the mouth and at the bottom, are increasingly widespread.

The method for labeling such bottles by means of circumferential labels, i.e., labels that wrap around the entire surface of the bottles, overlapping over a short portion at the leading and trailing edges, i.e., at the ends that are respectively at the front and at the rear in the approach of the label to the bottle, comprises, after positioning the labels, which rest against the bottles and are fixed thereto at their protrusions, a heat-shrinking step, which allows the labels to perfectly mate with the profile of the bottles.

If the labels are fixed to the bottles by using traditional adhesive, when heat-shrinking occurs, such adhesive breaks down, with consequent separation of the applied labels.

It has been thought, therefore, to adopt an adhesive of the type that polymerizes only as a consequence to exposure to UV rays, but if this adhesive is used, the action of the suction force that retains a label in contact with the drum for transferring it to the bottle may exceed the action, applied by the adhesive, that retains the label on the bottle during the first steps of separation from the transfer roller, and therefore the label does not separate from the transfer drum.

### SUMMARY OF THE INVENTION

The aim of the present invention is to provide a labeling machine for heat-shrink labels that ensures the perfect outcome of the operation.

This aim is achieved by a labeling machine for heat-shrink labels, according to the invention, comprising a rotating carousel provided with means for supporting the bottles to be labeled with circumferential labels, said means being adapted to turn the bottles about their axis so as to produce the adhesion, on a surface of said bottles, of the labels with an overlap at the leading and trailing edges of the label, characterized in that it comprises, arranged progressively along the path of the bottles:
a first adhesive bonding device, adapted to apply to the surface of the bottle a film of adhesive at a strip of limited dimensions;
a transfer drum, adapted to convey a label from a second adhesive bonding device, adapted to arrange a film of adhesive of the type that polymerizes as a consequence of exposure to UV rays on a strip located at a trailing edge of the label, until contact occurs with a bottle so that a leading edge of said label is located at the film of traditional adhesive applied previously;
at least one UV-ray emission lamp, located at a path traced by a bottle with the label permanently applied thereto and facing an overlap region of the leading and trailing edges of said label, which is provided with the film of adhesive arranged by the second adhesive bonding device.

### BRIEF DESCRIPTION OF THE DRAWINGS

Further characteristics and advantages will become better apparent from the description of a preferred but not exclusive embodiment of the invention, illustrated by way of non-limiting example in the accompanying drawings, wherein:

FIG. 1 is a plan view of the machine according to the invention;

FIG. 2 is a view of a detail of FIG. 1 during operation.

### DESCRIPTION OF THE PREFERRED EMBODIMENTS

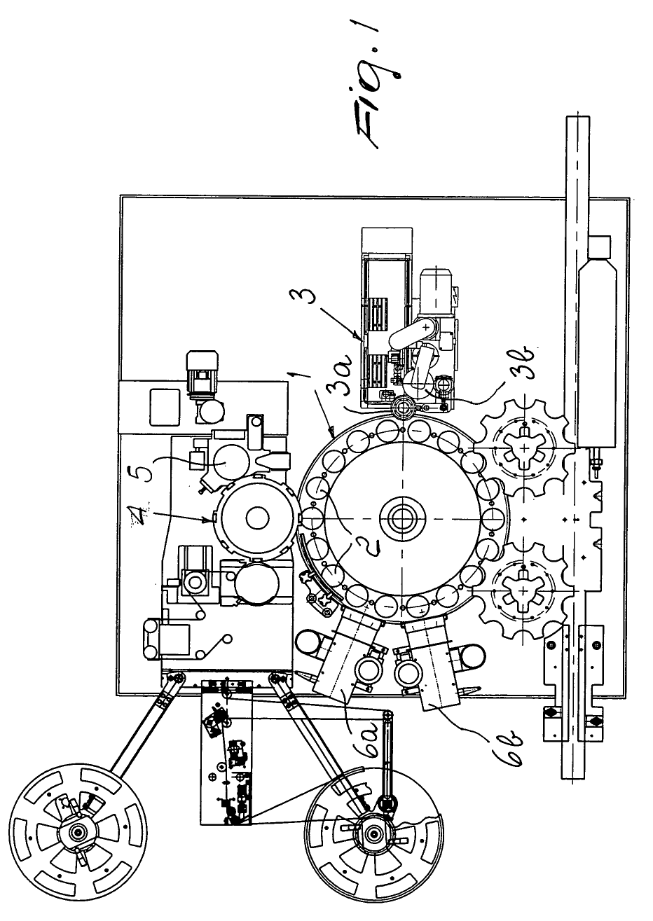

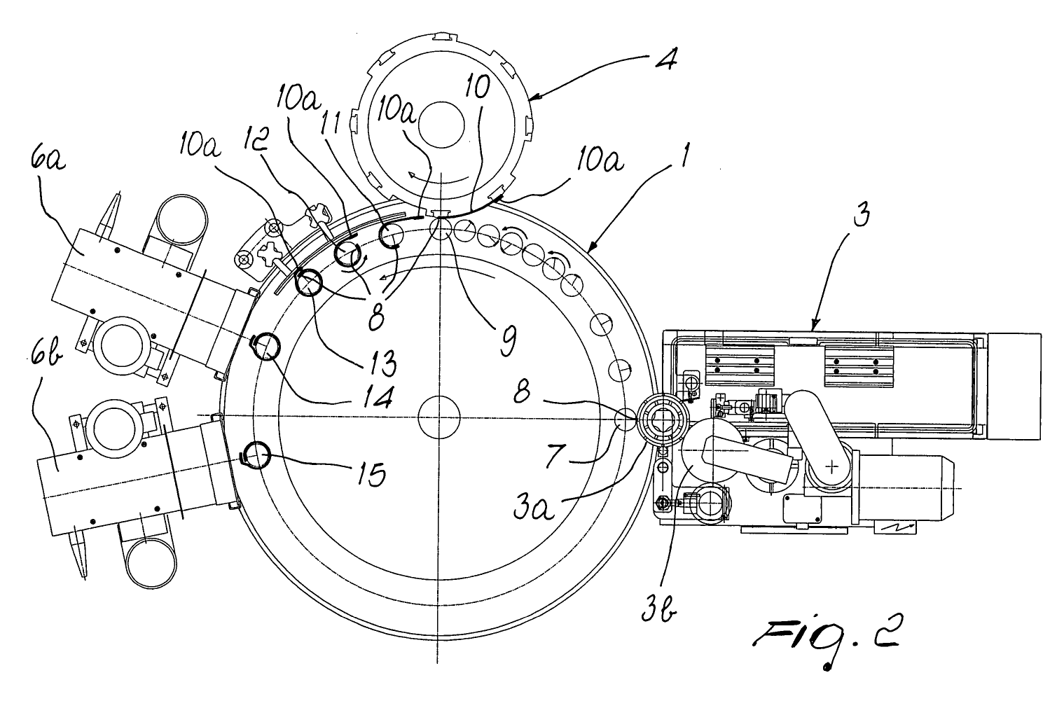

With reference to the figures, the reference numeral 1 generally designates a carousel, which rotates as shown by the arrow in FIG. 2 and is provided with means for supporting bottles to be labeled; such means comprise pans such as 2, which are shown only in FIG. 1, and FIG. 2 illustrates a bottle in the various positions it gradually occupies during labeling.

Each one of such pans is capable of turning the bottle that rests thereon about its own axis so as to produce the adhesion, on the surface of the bottle, of a circumferential label, i.e., of a label that wraps around the entire surface, with an overlap at a brief portion at the leading and trailing edges, i.e., at the ends that are respectively at the front and at the rear in the motion for approach of the label to the bottle.

The reference numeral 3 further generally designates a first adhesive bonding device, which comprises a silicone rubber roller 3a, which receives adhesive from a steel roller 3b, and is adapted to apply to the surface of a bottle a film of convention adhesive at a small strip, such as to be covered entirely by the overlap region of a label 10.

The reference numeral 4 further designates a transfer drum, which rotates in the direction of the arrow shown in FIG. 2, for transferring the labels, which are retained on the drum by a suitable suction force. Such drum gradually conveys each label from an adhesive-bearing roller 5 of a second adhesive bonding device, which is adapted to arrange a film 10a of adhesive of the type that polymerizes as a consequence of exposure to UV rays on a strip located at a trailing edge of the label, until contact occurs with a bottle so that a leading edge of the label lies at the film of traditional adhesive applied previously.

Finally, the reference numerals 6a, 6b designate two UV-ray emission lamps, which are arranged in the peripheral region of the carousel 1 at a path traced by a bottle, with the label permanently applied thereto and orientated so that the overlap region of the leading and trailing edges of the label is arranged toward the outside of the carousel.

Operation of the machine is now described with reference to FIG. 2.

When a bottle to be labeled reaches the position 7, it receives from the roller 3a a film of traditional adhesive at a strip 8 and the bottle is then turned about its own axis while the carousel moves it into the position 9, so that the strip of adhesive 8 lies at the leading edge of the label 10, which in the meantime is conveyed by means of the transfer roller 4 from the second adhesive bonding device, which applied to the trailing edge of the label the film 10a of adhesive of the type that polymerizes following exposure to UV rays.

In this manner, the correct passage of the label from the transfer roller 4 to the bottle is ensured.

The carousel conveys the bottle gradually into the positions 11, 12, 13 and at the same time the bottle rotates about its own axis so as to achieve the complete adhesion of the label 10 to its surface, with contact grip in the leading and trailing position 13 and with corresponding overlap provided with the film of adhesive 10a, with an underlying film of adhesive 8.

To complete the operation, the bottle then reaches positions 14 and 15, where the strip 10a of adhesive receives the emission of UV rays, with consequent polymerization adapted to produce a fixing of the label that will not be affected during the subsequent heat-shrinking operation, whereas the underlying strip 8 of traditional adhesive is meant to remain concealed, so that any deterioration thereof does not become evident.

The described invention is susceptible of numerous modifications and variations, all of which are within the scope of the appended claims: thus, for example, there may be a single UV-ray emission lamp, and the lamps may further be located at the output line of the bottles.

The disclosures in Italian Patent Application No. MN2004A000024 from which this application claims priority are incorporated herein by reference.

What is claimed is:

1. A labeling machine for heat-shrink labels, comprising a rotating carousel provided with means for supporting bottles to be labeled with circumferential labels, said means being adapted to turn the bottles about their axis so as to produce adhesion, on a surface of said bottles, of the labels with an overlap region at leading and trailing edges of the label, comprising, arranged progressively along a path of the bottles:
a first adhesive bonding device, adapted to apply to the surface of the bottle a film of adhesive at a strip of limited dimensions;
a transfer drum, adapted to convey a label from a second adhesive bonding device, adapted to arrange a film of adhesive of the type that polymerizes as a consequence of exposure to UV rays on a strip located at the trailing edge of the label, until contact occurs with a bottle so that the leading edge of said label is located at the film of adhesive applied previously;
at least one UV-ray emission lamp, located at the path traced by a bottle with the label permanently applied thereto and facing the overlap region of the leading and trailing edges of said label, which is provided with the film of adhesive arranged by the second adhesive bonding device.

2. The labeling machine according to claim 1, wherein the at least one UV-ray emission lamp is located in a peripheral region of the carousel.

3. The labeling machine according to claim 1, wherein the at least one UV-ray emission lamp is located at an output line of the bottles.
